(19) United States
(12) Patent Application Publication
(10) Pub. No.: US 2024/0327691 A1
(43) Pub. Date: Oct. 3, 2024

(54) SILICONE-BASED ADHESIVE FILM, OPTICAL MEMBER COMPRISING SAME, AND OPTICAL DISPLAY DEVICE COMPRISING SAME

(71) Applicant: SAMSUNG SDI CO., LTD., Yongin-si, Gyeonggi-do (KR)

(72) Inventors: Sung Hyun MUN, Suwon-si (KR); Ji Won KANG, Suwon-si (KR); Il Jin KIM, Suwon-si (KR); Dong Myeong SHIN, Suwon-si (KR); Do Young KIM, Suwon-si (KR)

(21) Appl. No.: 18/708,531

(22) PCT Filed: Nov. 2, 2022
(86) PCT No.: PCT/KR2022/017042

§ 371 Date: May 8, 2024

(30) Foreign Application Priority Data
Nov. 8, 2021 (KR) 10-2021-0151986

(51) Int. Cl. C09J 183/04; C08K 3/36; C08K 9/04; C09J 7/30; C09J 11/04

(52) U.S. Cl. CPC C09J 183/04; C09J 7/30; C09J 11/04; C08K 3/36; C08K 9/04; C08K 2201/005; C09J 2301/408; C09J 2400/10; C09J 2483/00

(57) ABSTRACT

Provided are a silicone-based adhesive film, an optical member including same, and an optical display device comprising same, the silicone-based adhesive film being formed of a composition including: a reactive silicone-based resin; an MQ-type silicone-based resin; inorganic particles having a reactive functional group; and a catalyst, and the silicone-based adhesive film having a peel strength of 20 gf/inch or more, as measured on the surface of a fingerprint-resistant layer.

### TECHNICAL FIELD

The present invention relates to a silicone-based adhesive film, an optical member including the same, and an optical display device including the same.

### BACKGROUND ART

Optical display devices include several elements for optical display devices stacked on light-emitting diode panels including an organic light-emitting diode panel. Recently, the use, storage, and manufacturing environments of optical display devices have become harsher, and there is a growing interest in a new optical display device such as a wearable device or a foldable device. In particular, as light-emitting diode panels become thinner and/or more flexible, there is an increasing need to protect light emitting diode panels from external impacts. A method of providing impact resistance by laminating a protective film on the outermost layer of an optical display device rather than a conventional glass plate is being considered. The protective film may be composed of a base film and an adhesive layer laminated on one side of the base film.

As users touch the outermost surface of the optical display device temporarily or repeatedly, the optical display device may be smudged or have a defective screen display because of fingerprints. Thus, an anti-fingerprint layer is generally laminated on the outermost surface. However, since the anti-fingerprint layer has a high water contact angle, it is difficult for a typical (meth)acrylic adhesive film to increase the peel strength on the anti-fingerprint layer. In consideration of the use of the base film in wearable devices or foldable devices, there is no choice but to use a film with excellent flexibility for the base film included in the protective film. To this end, a polyurethane-based film, specifically a transparent polyurethane-based film (CPU film), is used as the base film. However, the present inventors confirmed when attempting to form an adhesive layer after coating a CPU film with the composition for an adhesive layer, the curing of the composition was hindered by nitrogen contained in the CPU film, making it impossible for the adhesive layer to be properly formed.

The background technology of the present invention is disclosed in Korean Unexamined Patent Publication No. 2007-0055363.

### DISCLOSURE

### Technical Problem

One purpose of the present invention is to provide a silicone-based adhesive film that may be used as a protective film for an adherend for optical display devices.

Another purpose of the present invention is to provide a silicone-based adhesive film that has excellent peel strength and wetting properties on an adherend for optical display devices, which has a difficult-to-adhere-to anti-fingerprint layer, and exhibits excellent optical properties due to low haze.

Still another purpose of the present invention is to provide a silicone-based adhesive film that has excellent manufacturing processability by being formed of a composition for an adhesive film with a long pot life and excellent liquid stability.

Yet another purpose of the present invention is to provide a silicone-based adhesive film with improved processability due to a high curing degree when formed on one side of a transparent polyurethane-based film.

### Technical Solution

One aspect of the present invention provides a silicone-based adhesive film.
1. The silicone-based adhesive film is formed of a composition including: a reactive silicone-based resin; an MQ-type silicone-based resin; inorganic particles having a reactive functional group; and a catalyst, and the silicone-based adhesive film has a peel strength of 20 gf/inch or more on the surface of an anti-fingerprint layer.
2. In the preceding paragraph, the catalyst may be included in an amount of more than 0 ppm and 1 wt % or less.
3. In the preceding paragraphs 1 to 2, the MQ-type silicone-based resin may be a non-reactive silicone-based resin.
4. In the preceding paragraphs 1 to 3, the MQ-type silicone-based resin may include an organopolysiloxane resin containing an R¹R²R³SiO_{1/2} unit (R¹, R², and R³ are each independently an alkyl group having 1 to 6 carbon atoms) (M unit) and an SiO_{4/2} unit (Q unit).
5. In the preceding paragraphs 1 to 4, the MQ-type silicone-based resin may include an organopolysiloxane resin consisting of only M units and Q units.
6. In the preceding paragraphs 1 to 5, the reactive functional group may include one or more of an epoxy group, a (meth)acryloyloxy group, a (meth)acrylate group, and a mercapto group.
7. In the preceding paragraphs 1 to 6, the epoxy group may be a glycidoxy group, a glycidoxy propyl group, an epoxycyclohexyl group, an epoxycyclohexylethyl group, or an epoxycyclohexylmethyl group.
8. In the preceding paragraphs 1 to 7, the inorganic particles having the reactive functional group may have a refractive index of 1.3 to 2.0.
9. In the preceding paragraphs 1 to 8, the inorganic particles having the reactive functional group may have an average particle diameter (D50) of more than 0 nm and 10 μm or less.
10. In the preceding paragraphs 1 to 9, the inorganic particles having the reactive functional group may include silica.
11. In the preceding paragraphs 1 to 10, the inorganic particles having the reactive functional group may be included in an amount of 20 parts by weight to 70 parts by weight based on a total of 100 parts by weight of the reactive silicone-based resin and the inorganic particles having the reactive functional group.
12. In the preceding paragraphs 1 to 11, the reactive silicone-based resin may include an organopolysiloxane containing at least one silicon-bonded vinyl group at a side chain or both ends.
13. In the preceding paragraphs 1 to 12, in the composition,
the reactive silicone-based resin may be included in an amount of 30 parts by weight to 80 parts by weight and the inorganic particles having the reactive functional group may be included in an amount of 20 parts by weight to 70 parts by weight, based on a total of 100 parts by weight of the reactive silicone-based resin and the inorganic particles having the reactive functional group, and
the MQ-type silicone-based resin may be included in an amount of 1 part by weight to 30 parts by weight based on a total of 100 parts by weight of the reactive silicone-based resin and the inorganic particles having the reactive functional group.
14. In the preceding paragraphs 1 to 13, the composition may further include a cross-linking agent.
15. In the preceding paragraphs 1 to 14, the anti-fingerprint layer may have a water contact angle of 95° or more at 25° C.

An optical member of the present invention includes: an adherend for optical display devices; and the silicone-based adhesive film of the present invention laminated on one side of the adherend for optical display devices.

The optical display device of the present invention includes the silicone-based adhesive film of the present invention or the silicone-based optical member of the present invention.

### Advantageous Effects

The present invention provides a silicone-based adhesive film that can be used as a protective film for an adherend for optical display devices.

The present invention provides a silicone-based adhesive film that has excellent peel strength and wetting properties on an adherend for optical display devices, which has a difficult-to-adhere-to anti-fingerprint layer, and exhibits excellent optical properties due to low haze.

The present invention provides a silicone-based adhesive film that has excellent manufacturing processability by being formed of a composition for an adhesive film with a long pot life and excellent liquid stability.

The present invention provides a silicone-based adhesive film with improved processability due to a high curing degree when formed on one side of a transparent polyurethane-based film.

### DESCRIPTION OF DRAWINGS

FIG. 1 is a cross-sectional view showing an optical member of an optical display device according to an embodiment of the present invention, which is attached to one side of an adherend for optical display devices.

### BEST MODES OF THE INVENTION

The present invention will be described in detail with reference to the attached drawing and embodiments so that those skilled in the art can easily implement the present invention. The present invention may be implemented in many different forms and is not limited to the embodiments described herein.

In the drawing, to clearly describe the present invention, parts not related to the description are omitted, and the same names are used for identical or similar components throughout the specification. The length and size of each component in the drawing are for illustrative purposes, and the present invention is not limited to the length and size of each component depicted in the drawing. In this specification, the “upper” and “lower” are defined based on the drawing, and the “upper” may be changed to “lower,” and “lower” may be changed to “upper,” depending on the viewing angle.

In this specification, “(meth)acrylic” may mean acrylic and/or methacrylic.

In this specification, “peel strength” is the value measured after cutting a laminate, in which the silicone-based adhesive film of the present invention is laminated on one side of a transparent polyurethane-based film, into a 100 mm×25 mm (width×height) piece, laminating it on a 100 mm×25 mm (width×heigh) PET film laminate in which an anti-fingerprint layer is formed on an upper surface (NRF75, SKC Co., Ltd., the anti-fingerprint layer is fluorine-based layer, the thickness of the film laminate is 75 μm, and the water contact angle of the anti-fingerprint layer is 105° at 25° C.) so that the silicone-based adhesive film and the anti-fingerprint layer are bonded to prepare a sample, attaching the prepared sample to a peel strength measurement device, TA.XT Plus Texture Analyzer (TA Instruments), and peeling the laminate of the silicone-based adhesive film and the polyurethane-based film off of the anti-fingerprint layer at a peeling temperature of 25° C., a peeling speed of 300 mm/min, and a peeling angle of 180° to measure the peel strength.

In this specification, in describing a numerical range, the phrase “X to Y” means X or more and Y or less (X≤ and ≤Y).

The present invention may be used as a protective film for an adherend for optical display devices, and the present invention provides a silicone-based adhesive film that has excellent peel strength and wetting properties on an adherend for optical display devices, which has a difficult-to-adhere-to anti-fingerprint layer, exhibits excellent manufacturing processability by being formed of a composition for an adhesive film with a long pot life and excellent liquid stability, and has excellent processability by being formed on a transparent polyurethane-based film with a high curing degree.

Hereinafter, a silicone-based adhesive film according to an embodiment of the present invention will be described.

The silicone-based adhesive film has a peel strength of 20 gf/inch or more on the surface of an anti-fingerprint layer. The anti-fingerprint layer is disposed on the outermost layer of the adherend for optical display devices. The anti-fingerprint layer may prevent optical display devices from being smudged or having a defective screen display due to the fingerprints after touching the adherend. The adhesive film of the present invention has excellent wetting properties on the surface of the anti-fingerprint layer and a peel strength within the above-described range, thereby providing protection to the adherend for optical display devices, which has an anti-fingerprint layer. For example, the peel strength may be 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, and 60 gf/inch, and it may preferably be 20 gf/inch to 60 gf/inch.

Hereinafter, the anti-fingerprint layer will be described.

Since the anti-fingerprint layer is known as a layer that is difficult to adhere to, it is not easy to achieve a peel strength of 20 gf/inch or more with a typical silicone-based adhesive film or (meth)acrylic adhesive film. There may be several complicated reasons, but one may be a high water contact angle on the surface of the anti-fingerprint layer as the anti-fingerprint layer is formed of a composition containing a fluorine-based or silicon-based material.

The silicone-based adhesive film of the present invention may have peel strength on the surface of the anti-fingerprint layer, which has a water contact angle of 95° or more at 25° C., for example, 105° to 150° or 110° to 150°. The “water contact angle” may be measured at 25° C. by conventional methods known to those skilled in the art. For example, the water contact angle may be obtained by dropping a drop of water on the surface of the anti-fingerprint layer to measure the angle between the anti-fingerprint layer and the water droplet or using a contact angle measurement device.

The anti-fingerprint layer may be formed of a fluorine-based composition, a silicon-based composition, or a composition containing both fluorine and silicon. The water contact angle of the fluorine-based anti-fingerprint layer may be realized by adjusting the type and/or content of the fluorine-based material. The water contact angle of the silicon-based anti-fingerprint layer may be realized by adjusting the type and/or content of the silicon-based material. The water contact angle of the anti-fingerprint layer containing both fluorine and silicon may be realized by adjusting the type of fluorine-based material, the content of the fluorine-based material, the type of silicon-based material, and/or the content of the silicon-based material.

In an embodiment, the anti-fingerprint layer may be formed of a composition containing a fluorine-based copolymer resin. The fluorine-based copolymer resin may be formed of one or more types selected from a fluorine-based alkyl compound and a fluorine-based silane coupling agent. For example, it may be a copolymer of fluorine-containing acrylic resin, trifluoropropyltrimethoxysilane, trifluoropropyltriethoxysilane, heptafluoropropyltrimethoxysilane, and the like. The composition may further include one or more of a polyester resin, a polyurethane resin, an isocyanate-based compound, and alkoxysilane as a binder for forming an anti-fingerprint layer, but is not limited thereto.

When the peel strength of the present invention is measured, a PET film laminated with an anti-fingerprint layer may be used. The anti-fingerprint layer may have a thickness of 0.1 μm to 5 μm.

Since the silicone-based adhesive film has excellent optical properties, it may have low haze. In an embodiment, the silicone-based adhesive film has a haze of 1% or less, for example, 0, 0.1, 0.2, 0.3, 0.4, 0.5, 0.6, 0.7, 0.8, 0.9, 1%, and it may preferably be 0% to 0.5%.

The silicone-based adhesive film may have a thickness of 50 μm or less, such as more than 0 μm, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 μm, preferably more than 0 μm and 50 μm or less, more preferably 5 μm to 30 μm. Within the above range, the silicone-based adhesive film may protect the adherend and be used in optical display devices.

The silicone-based adhesive film may be formed of a composition for an adhesive film which includes: a reactive silicone-based resin; an MQ-type silicone-based resin; inorganic particles having a reactive functional group; and a catalyst. The composition may further include a cross-linking agent. The composition may further include various additives.

The silicone-based adhesive film may be manufactured by applying the above-described composition for an adhesive film to one side of a polyurethane-based film, preferably a transparent polyurethane-based film, followed by solvent drying and aging. The silicone-based adhesive film is included in silicone-based pressure sensitive adhesive (PSA) films.

Hereinafter, the composition for an adhesive film of the present invention will be described.

### Reactive Silicone-Based Resin

The reactive silicone-based resin is an adhesive resin, which forms a matrix of the silicone-based adhesive film after curing and may help increase the peel strength of the silicone-based adhesive film.

The reactive silicone-based resin has an alkenyl group or an alkenyl group-containing group as a reactive group and may undergo a curing reaction with a cross-linking agent described below. The reactive group may preferably be a vinyl group or a vinyl group-containing group. The “vinyl group-containing group” may be “*-alkylene group having 1 to 5 carbon atoms-CH═CH₂” (* is the binding site of an element).

The reactive silicone-based resin may include a silicone-based resin having one or more of a vinyl group directly bonded to silicon (Si) (Si—CH═CH₂) and a vinyl group bonded to silicon (Si) through a linking group (Si-[linking group]-CH═CH₂). The “linking group” is an alkylene group having 1 to 5 carbon atoms, and may be, for example, a methylene group, an ethylene group, a propylene group, a butylene group, or a pentylene group.

Preferably, the reactive silicone-based resin may increase the peel strength on the surface of the anti-fingerprint layer by having one or more vinyl groups directly bonded to silicon (Si—CH═CH₂) in the molecule.

The reactive silicone-based resin is a linear organopolysiloxane and may include a polydiorganosiloxane unit.

The reactive silicone-based resin may include an organopolysiloxane having at least one silicon-bonded vinyl group at a side chain or both ends.

In an embodiment, the reactive silicone-based resin may not include an SiO_{4/2} unit (Q unit).

For example, the reactive silicone-based resin may be an organic polysiloxane having any one of the following Chemical Formula 1 and Chemical Formula 2:

[Chemical Formula 1]

(R¹R²SiO_{2/2})x(R³R⁴SiO_{2/2})y(R⁵R⁶SiO_{2/2})z
(in Chemical Formula 1,
R¹ and R² are each independently a C₁ to C₁₀ alkyl group or a vinyl group,
R³ and R⁴ are each independently a C₁ to C₁₀ alkyl group or a vinyl group,
R⁵ and R⁶ are each independently a C₁ to C₁₀ alkyl group, a C₆ to C₂₀ aryl group, or a vinyl group,
at least one of R¹ and R² is a vinyl group, and
0<x≤1, 0≤y<1, 0≤z<1, x+y+z=1).

In Chemical Formula 1, preferably, x may be more than 0 and 0.7 or less, such as more than 0, 0.1, 0.2, 0.3, 0.4, 0.5, 0.6, and 0.7, y may be 0 to 0.7, such as 0, more than 0, 0.1, 0.2, 0.3, 0.4, 0.5, 0.6, and 0.7, and z may be 0 to 0.7, such as 0, more than 0, 0.1, 0.2, 0.3, 0.4, 0.5, 0.6, and 0.7. Within these ranges, peel strength may be further increased.

[Chemical Formula 2]

R⁷R⁸R⁹SiO—(R¹R²SiO_{2/2})x(R³R⁴SiO_{2/2})y(R⁵R⁶SiO_{2/2})z-SiR¹⁰R¹¹R¹²
(In Chemical Formula 2,
R¹, R², R³, R⁴, R⁵, and R⁶ are each independently a C₁ to C₁₀ alkyl group, a C₆ to C₂₀ aryl group, or a vinyl group,
R⁷, R⁸, and R⁹ are each independently a vinyl group or a C₁ to C₁₀ alkyl group,
at least one of R⁷, R⁸, and R⁹ is a vinyl group,
R¹⁰, R¹¹, and R¹² are each independently a vinyl group or a C₁ to C₁₀ alkyl group,
at least one of R¹⁰, R¹¹, and R¹² is a vinyl group, and
0≤x≤1, 0≤y≤1, 0≤z≤1, x+y+z=1.)

In Chemical Formula 2, preferably, x may be 0 to 0.7, such as 0, more than 0, 0.1, 0.2, 0.3, 0.4, 0.5, 0.6, and 0.7, y may be 0 to 0.7, such as 0, more than 0, 0.1, 0.2, 0.3, 0.4, 0.5, 0.6, and 0.7, and z may be 0 to 0.7, such as 0, more than 0, 0.1, 0.2, 0.3, 0.4, 0.5, 0.6, and 0. Within these range, peel strength may be further increased.

The reactive silicone-based resin of Chemical Formula 1 may be end-capped to include the reactive silicone-based resin of Chemical Formula 3 below:

[Chemical Formula 3]

R⁷R⁸R⁹SiO—(R¹R²SiO_{2/2})x(R³R⁴SiO_{2/2})y(R⁵R⁶SiO_{2/2})z-SiR¹⁰R¹¹R¹²
(in Chemical Formula 3,
R¹, R², R³, R⁴, R⁵, R⁶, x, y, and z are as defined in Chemical Formula 1,
R⁷, R⁸, and R⁹ are each independently a vinyl group or a C₁ to C₁₀ alkyl group,
R¹⁰, R¹¹, and R¹² are each independently a vinyl group or a C₁ to C₁₀ alkyl group).

In Chemical Formula 3, preferably, x may be 0 to 0.7, such as 0, more than 0, 0.1, 0.2, 0.3, 0.4, 0.5, 0.6, and 0.7, y may be 0 to 0.7, such as 0, more than 0, 0.1, 0.2, 0.3, 0.4, 0.5, 0.6, and 0.7, and z may be 0 to 0.7, such as 0, more than 0, 0.1, 0.2, 0.3, 0.4, 0.5, 0.6, and 0.7. Within these ranges, peel strength may be further increased.

Preferably, in Chemical Formula 1, Chemical Formula 2, and Chemical Formula 3, the “C₁ to C₁₀ alkyl group” is a C₁ to C₅ alkyl group, such as a methyl group, an ethyl group, a propyl group, a butyl group, and a pentyl group, and more preferably, it may be a methyl group.

Preferably, in Chemical Formula 1, Chemical Formula 2, and Chemical Formula 3, the “C₆ to C₂₀ aryl group” may be a C₆ to C₁₀ aryl group, and more preferably, it may be a phenyl group.

In an embodiment, Chemical Formula 1 may be ((CH₃)ViSiO_{2/2})x-((CH₃)₂SiO_{2/2})y (where 0<x<1, 0<y<1, x+y=1, Vi is a vinyl group) or ((CH₃)ViSiO_{2/2})x-((CH₃)₂SiO_{2/2}) y-((Ph₂SiO_{2/2})z (where 0<x<1, 0<y<1, 0<z<1, x+y+z=1, Vi is a vinyl group, Ph is a phenyl group).

In an embodiment, Chemical Formula 2 may be (CH₃)₂ ViSiO—((CH₃)₂SiO_{2/2})x-SiVi(CH₃)₂ (where Vi is a vinyl group).

In an embodiment, Chemical Formula 3 may include an organopolysiloxane containing (CH₃)₃SiO—((CH₃)ViSiO_{2/2})x-((CH₃)₂SiO_{2/2})y-Si(CH₃)₃(where 0<x<1, 0<y<1, x+y=1, Vi is a vinyl group) or (CH₃)₃SiO-(Vi(CH₃)SiO_{2/2})x-((CH₃)₂SiO_{2/2})y-(Ph₂SiO_{2/2})z-Si(CH₃)₃ (where 0<x<1, 0<y<1, 0<z<1, x+y+z=1, Vi is a vinyl group, Ph is a phenyl group).

Only one type of reactive silicone-based resin may be used, or two or more types of reactive silicone-based resin may be included.

The reactive silicone-based resin may have a molecular weight of 20,000 to 300,000, preferably 30,000 to 200,000. Within this range, peel strength and wetting properties may be improved. The molecular weight is a number average molecular weight and may be measured by conventional methods known to those skilled in the art.

One or more types of resins in Chemical Formula 1, Chemical Formula 2, and Chemical Formula 3 may be included in an amount of 90 wt % or more, for example, 95 wt % to 100 wt %, of the total reactive silicone-based resin in the composition for an adhesive film. Within the above range, the effects of the present invention may be easily implemented.

The reactive silicone-based resin may be included in an amount of 30 parts by weight to 80 parts by weight, such as 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80 parts by weight, preferably 40 parts by weight to 80 parts by weight, 50 parts by weight to 80 parts by weight, based on a total of 100 parts by weight of the reactive silicone-based resin and the inorganic particles having the reactive functional group described below. Within this range, peel strength may be improved.

### MQ-Type Silicone-Based Resin

The present inventors confirmed that among silicone-based adhesive films, an adhesive film formed of the composition for an adhesive film including only a reactive silicone-based resin as a silicone-based resin cannot have a peel strength of 20 gf/inch or more, and there is a limit to increasing the peel strength. Thus, the present inventors included a mixture containing two or more different silicone-based resins including a reactive silicone-based resin and an MQ-type silicone-based resin.

The MQ-type silicone-based resin included in the adhesive film may help increase adhesion to the anti-fingerprint layer and improve wetting properties.

Unlike the reactive silicone-based resin, the MQ-type silicone-based resin may be a non-reactive silicone-based resin that does not have a reactive group. A silicone-based adhesive film that includes an MQ-type silicone-based resin having a reactive group instead of a non-reactive MQ-type silicone-based resin may have the problem of lower peel strength on the anti-fingerprint layer compared to the use of a non-reactive MQ-type silicone-based resin. The non-reactive MQ-type silicone-based resin may be included in an amount of 90 wt % or more, for example, 95 wt % to 100 wt %, 90, 91, 92, 93, 94, 95, 96, 97, 98, 99, 100 wt %, of the total MQ-type silicone-based resin contained in the composition for an adhesive film. Within the above range, the effects of the present invention may be easily implemented.

The MQ-type silicone-based resin may include an organopolysiloxane resin containing an R¹R²R³SiO_{1/2} unit (R¹, R², and R³ are described in detail below) (M unit) and an SiO_{4/2} unit (Q unit).

In the R¹R²R³SiO_{1/2} unit, R¹, R², and R³ are each independently an alkyl group having 1 to 6 carbon atoms, and for example, R¹, R², are R³ may be a propyl group such as a methyl group, an ethyl group, an isopropyl group, or n-propyl group. In an embodiment, in the R¹R²R³SiO_{1/2} unit, two or more or three or more of R¹, R², and R³may be methyl groups.

In an embodiment, the MQ-type silicone-based resin may include, as a siloxane unit, an organopolysiloxane resin consisting of an R¹R²R³SiO_{1/2} unit (R¹, R², and R³ are described in detail above) (M unit) and an SiO_{4/2} unit (Q unit).

In the MQ-type silicone-based resin, among the R¹R²R³SiO_{1/2} and SiO_{4/2} units, the molar ratio of the R¹R²R³SiO_{1/2} unit to the SiO_{4/2} unit may be 0.5:1 to 1.5:1, 0.5:1, 0.6:1, 0.7:1, 0.8:1, 0.9:1, 1:1, 1.1:1, 1.2:1, 1.3:1, 1.4:1, 1.5:1, and it may preferably be 0.7:1 to 1.3:1. Within the above range, the effect of improving the wetting properties on the anti-fingerprint layer may be achieved. The “molar ratio” may be obtained by measuring silicon NMR of the silicone-based adhesive protective film and the area ratio of the R¹R²R³SiO_{1/2} unit and the SiO_{4/2} unit, but is not limited thereto.

The MQ-type silicone-based resin may be included in an amount of 1 part by weight to 30 parts by weight, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 parts by weight, preferably 1 part by weight to 15 parts by weight, based on 100 parts by weight of the reactive silicone-based resin. Within the above range, adhesion may be improved and peel strength may be increased.

Based on a total of 100 parts by weight of the reactive silicone-based resin and the inorganic particles having the reactive functional group described below, the MQ-type silicone-based resin may be included in an amount of 1 part by weight to 30 parts by weight, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 parts by weight, and it may preferably be included in an amount of 1 part by weight to 15 parts by weight. Within the above range, adhesion may be improved and peel strength may be increased.

### Inorganic Particles Having a Reactive Functional Group

Inorganic particles having a reactive functional group (hereinafter also referred to as “inorganic particles”) may increase the peel strength on the surface of the anti-fingerprint layer of the adhesive film by increasing the cohesion of the silicone-based adhesive film, enhance the liquid stability of the composition, and improve processability by contributing to increasing the curing degree of the adhesive film when attempting to form an adhesive film after coating a transparent polyurethane-based film with the composition.

The present inventors confirmed that the wetting properties and peel strength on the surface of the anti-fingerprint layer were significantly increased by additionally including a mixture of the MQ-type silicone-based resin and inorganic particles in the reactive silicone-based resin. When a compound having a reactive group without inorganic particles, such as a silane coupling agent, is included or inorganic particles having a non-reactive functional group is included, the effect of increasing the peel strength on the surface of the anti-fingerprint layer was insignificant. Based on the total inorganic particles contained in the composition for an adhesive film or the adhesive film, the inorganic particles having the reactive functional group may be contained in an amount of 90 wt % or more, for example, 95 wt % to 100 wt %. Within the above range, the effects of the present invention may be easily implemented.

Preferably, inorganic particles having a reactive functional group may be surface treated with one or more of an epoxy group, a (meth)acryloyloxy group, a (meth)acrylate group, and a mercapto group (SH) as a functional group that is reactive with the reactive silicone-based resin.

The epoxy group, the (meth)acryloyloxy group, the (meth)acrylate group, and the mercapto group may improve the manufacturing processability of the adhesive film of the present invention by extending the pot life of the composition for an adhesive film and improving liquid stability.

As a base film used to form an adhesive film and used in optical display devices, a polyurethane-based film, specifically a transparent polyurethane-based film (CPU film) is used. However, the present inventors confirmed that when attempting to form an adhesive film after coating a CPU film with the composition for an adhesive film, the curing of the composition was hindered by nitrogen contained in the CPU film, making it impossible for the adhesive film to be properly formed. When the catalyst is included in the range described below, the curing rate of the adhesive film composition may be increased, but the catalyst catalyzes the curing reaction of the adhesive film composition at an unwanted time, thereby reducing the liquid stability and pot life of the adhesive film. Inorganic particles surface treated with one or more of an epoxy group, a (meth)acryloyloxy group, a (meth)acrylate group, and a mercapto group may increase the liquid stability and pot life of the composition for an adhesive film.

Preferably, the inorganic particles may include an epoxy group. The epoxy group will be described in detail.

The “epoxy group” may be an epoxide group, an epoxide group-containing group, a glycidyl group, a glycidyl group-containing group, a glycidoxy group, a glycidoxy group-containing group, an epoxidized C₆ to C₁₀ alicyclic group, and an epoxidized C₆ to C₁₀ alicyclic group-containing group. For example, the epoxy group may be a glycidoxy group, a glycidoxy propyl group, an epoxycyclohexyl group, an epoxycyclohexylethyl group, an epoxycyclohexylmethyl group, and the like.

The reactive functional group in inorganic particles may be included in an amount of 0 to 100%, preferably 0% to 90%, based on the total surface area of the inorganic particles. Within the above range, the optical properties are not lowered due to good compatibility with the organic matrix for the silicone-based adhesive film, and the effects of the present invention may be easily implemented.

The inorganic particles may include inorganic particles having a refractive index of 1.3 to 2.0, for example, 1.3, 1.4, 1.5, 1.6, 1.7, 1.8, 1.9, 2.0, preferably 1.4 to 1.8. Within the above range, by having an appropriate refractive index compared to the matrix of the silicone-based adhesive film, it is possible to prevent an increase of the haze of the silicone-based adhesive film. In an embodiment, the inorganic particles may include one or more of silica and zirconia. Preferably, compatibility with the matrix of the silicone-based adhesive film may be excellent by using silica as the inorganic particle. The silica may include one or more of solid silica and hollow silica.

The shape of the inorganic particles is not particularly limited. In an embodiment, the inorganic particles may be spherical, oval, amorphous, and the like. The inorganic particles may have an average particle diameter (D50) of more than 0 nm and 10 μm or less, for example, more than 0 nm, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 300, 400, 500, 600, 700, 800, 900, 1000, 1100, 1200, 1300, 1400, 1500, 1600, 1700, 1800, 1900, 2000, 3000, 4000, 5000, 6000, 7000, 8000, 9000, and 10000 nm, and specifically, it may be 1 nm to 200 nm. Within the above range, the inorganic particles may be included in the silicone-based adhesive film. The “average particle diameter (D50)” may be measured by conventional methods known to those skilled in the art or referring to the product catalog. For example, the “average particle diameter (D50)” may mean the particle size of the inorganic particles corresponding to 50 vol % or 50 wt % when the inorganic particles are distributed in order from minimum to maximum based on volume or weight.

Based on a total of 100 parts by weight of the reactive silicone-based resin and inorganic particles, the inorganic particles may be included in an amount of 20 parts by weight to 70 parts by weight, for example, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, and 70 parts by weight, preferably 20 parts by weight to 60 parts by weight, 20 parts by weight to 50 parts by weight. Within the above range, cohesion and peel strength may be improved.

The inorganic particles may be manufactured using commercially available products or by conventional methods known to those skilled in the art. For example, the inorganic particles may be manufactured by treating the inorganic particles with a compound having the reactive group before the surface treatment.

### Catalyst

The catalyst may catalyze the reaction between reactive silicone-based resins and/or the reaction between a reactive silicone-based resin and a cross-linking agent.

The catalyst is a hydrosilylated catalyst and may include, for example, a platinum-based, ruthenium-based, or osmium-based catalyst. Specific types of catalysts may include conventional platinum catalysts known to those skilled in the art. For example, the catalyst may include chloroplatinic acid, an alcohol solution of chloroplatinic acid, a complex of chloroplatinic acid and an olefin, a complex of chloroplatinic acid and an alkenyl siloxane, but is not limited thereto.

The catalyst may be included in an amount of 300 ppm to 1 wt % in the adhesive film or the composition for an adhesive film based on solid content. Within the above range, when forming an adhesive film from the composition for an adhesive film on a transparent polyurethane-based film, the curing degree of the adhesive film may be increased. Preferably, the catalyst may be included at 300 ppm to 800 ppm.

The catalyst may be included in an amount of more than 0 ppm and 1 wt % or less, preferably 10 ppm to 2000 ppm or 250 ppm to 800 ppm, in the adhesive film or the composition for an adhesive film based on solid content. Within the above range, the curing degree of the adhesive film may be increased.

### Cross-Linking Agent

The cross-linking agent may cure the composition for an adhesive film by performing a hydrosilylation reaction with the reactive group of the reactive silicone resin. The cross-linking agent may include hydrogen organopolysiloxane having two or more silicon-bonded hydrogen (Si—H) elements in the molecule.

In an embodiment, the cross-linking agent may be represented by Chemical Formula 4 below:

[Chemical Formula 4]

R⁴R⁵R⁶SiO—(R¹R²SiO_{2/2})x(HR³SiO_{2/2})y-SiR⁷R⁸R⁹
(in Chemical Formula 4,
R¹, R², R³, R⁴, R⁵, R⁶, R⁷, R⁸, and R⁹ are each independently an alkyl group having 1 to 10 carbon atoms, and
0≤x<1, 0<y≤1, x+y=1).

The cross-linking agent may be included in an amount of 0 parts by weight to 5 parts by weight, preferably more than 0 parts by weight and 2 parts by weight or less, 0.1 parts by weight to 2 parts by weight, based on 100 parts by weight of the reactive silicone-based resin. Within the above range, the curing degree of the composition for an adhesive film may be increased.

### Additive

The additive may further include commonly used additives such as an antistatic agent, a surfactant, an ionic liquid, a lithium salt, an inorganic filler, a softener, a molecular weight regulator, an antioxidant, an anti-aging agent, a stabilizer, a leveling agent, an anti-foaming agent, a plasticizer, a dye, a pigment (such as a colored pigment, an extender pigment, and the like), a treatment agent, a UV blocker, a fluorescent whitening agent, a dispersant, a heat stabilizer, a light stabilizer, a UV absorber, a coagulant, and a lubricant.

Based on a total of 100 parts by weight of the reactive silicone-based resin and inorganic particles having a reactive functional group, the additive may be included in an amount of 0.001 parts by weight to 1 part by weight, specifically 0.003 parts by weight to 1 part by weight, more specifically 0.005 parts by weight to 1 part by weight. Within the above range, the effect of the additive may be achieved without affecting the peel strength and reliability of the adhesive film.

The composition may further include a solvent. The solvent may increase the applicability of the composition. Solvents commonly known to those skilled in the art, including toluene, may be used. The solvent may be included as the remainder of the composition excluding the solid content.

The silicone-based adhesive film may be manufactured by applying the composition to a base film to a predetermined thickness and then performing heat curing (aging).

In an embodiment, the base film may include a polyester film such as polyethylene terephthalate, a transparent polyurethane-based film, and the like, but is not limited thereto. The base film may have a thickness of 10 μm to 100 μm, preferably 50 μm to 80 μm. In an embodiment, heat curing may be performed by heat treatment at 50° C. to 120° C. for 1 to 5 days.

Preferably, a transparent polyurethane-based film may be used as the base film. Since the transparent polyurethane-based film has excellent flexibility, it may be easily used in wearable devices or foldable devices.

The transparent polyurethane-based film may include a polyurethane-based resin prepared from a bifunctional or higher multifunctional polyol and a bifunctional or higher multifunctional isocyanate. The polyol may include one or more of an aromatic polyol, an aliphatic polyol, and an alicyclic polyol. Preferably, it may be a polyurethane formed of one or more of an aliphatic polyol and an alicyclic polyol. The polyol may include one or more of a polyester diol, a polycarbonate diol, a polyolefin diol, a polyether diol, a polythioether diol, a polysiloxane diol, a polyacetal diol, and a polyesteramide diol, but is not limited thereto.

The multifunctional isocyanate may include any aliphatic, cycloaliphatic, or aromatic isocyanate. Chain extenders may include diols such as aliphatic diols, amino alcohols, diamines, hydrazine, hydrazide, or mixtures thereof. When thermoplastic polyurethane is manufactured, as a catalyst that promotes the formation of urethane bonds, a tin compound such as a tin salt of carboxylic acid, an amine such as dimethylcyclohexylamine, or triethylenediamine may be further included. When a polyurethane-based resin is manufactured, other common components such as a surfactant, a flame retardant, a filler, a pigment may be further included.

The transparent polyurethane-based film may have a light transmittance of 90% or more, preferably 95% to 100%.

Hereinafter, an optical member according to an embodiment of the present invention will be described.

The optical member according to an embodiment of the present invention includes a base film and an adhesive film formed on at least one side of the base film, and the adhesive film includes a silicone-based adhesive film according to an embodiment of the present invention.

The base film may be a polyester film such as polyethylene terephthalate and a transparent polyurethane-based film. Preferably, the base film may include the transparent polyurethane-based film.

Hereinafter, an optical display device according to an embodiment of the present invention will be described.

The optical display device according to an embodiment of the present invention includes the adhesive film of the present invention or the optical member of the present invention. The optical display device may include a light emitting display device, such as an organic light emitting display device, a liquid crystal display device, and the like, but is not limited to thereto. The optical display device may include a flexible device or a non-flexible device, but is not limited thereto.

In an embodiment, the optical display device may include the adhesive film of the present invention, a base film laminated on the upper surface of the adhesive film, and an adherend for optical display devices laminated on the lower surface of the adhesive film and whose outermost layer is an anti-fingerprint layer.

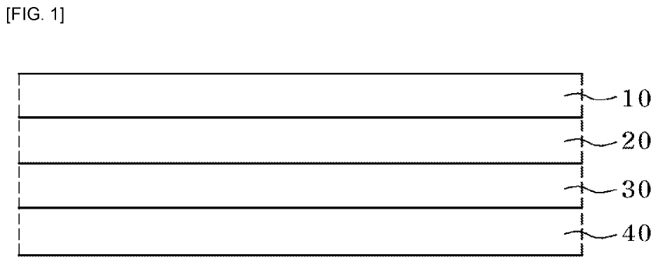

FIG. 1 is a cross-sectional view showing an optical member of an embodiment of the present invention attached to one side of an adherend for optical display devices.

Referring to FIG. 1, the optical display device includes a base film 10, an adhesive film 20, an anti-fingerprint layer 30 as the outermost layer, and an adherend 40 for optical display devices laminated on the lower surface of the anti-fingerprint layer 30, and the adhesive film 20 may include the silicone-based adhesive film of the present invention.

The base film 10 and the adhesive film 20 are the same as described above.

The anti-fingerprint layer 30 may be formed of a fluorine-based composition, silicon-based composition, or a composition containing both fluorine and silicon. For example, the anti-fingerprint layer may be formed of a composition containing one or more of fluorine-based (meth)acrylate and silicone-based (meth)acrylate. Fluorine-based (meth)acrylate and silicone-based (meth)acrylate may be selected from commonly used types in the art related to anti-fingerprint layers.

In an embodiment, the anti-fingerprint layer 30 may have a water contact angle of 95° or more at 25° C., and it may be, for example, 105° to 150° or 110° to 150°.

The adherend 40 for optical display devices may include one or more of an optical film, a polarizer, a light emitting device panel, a touch panel, a conductive film, and a brightness enhancement film, but is not limited thereto.

### Modes of the Invention

Hereinafter, the configuration and operation of the present invention will be described in more detail through preferred examples of the present invention. However, these are preferred examples of the present invention and should not be construed as limiting the present invention in any way.

Hereinafter, specific specifications of the components used in the examples and comparative examples are as follows.

### Component A

7663 (including a reactive silicone-based resin containing polydimethylsiloxane and capped with dimethylvinyloxy groups on silicon (Si) at both ends, silica with an epoxy group, and a cross-linking agent and commercially available from Dow Chemical Company)

### Component B

7657 (including a reactive silicone-based resin containing polydimethylsiloxane and capped with dimethylvinyloxy groups on silicon (Si) at both ends, silica with a methyl group, and a cross-linking agent and commercially available from Dow Chemical Company)

### Component C

Solution containing MQ-type silicone-based resin: 7426 (containing non-reactive MQ-type silicone-based resin having only (CH₃)₃SiO_{1/2} units as M units and SiO_{4/2} units and commercially available from Dow Chemical Company)

### Component D

Catalyst: 4000 (hydrosilylated platinum catalyst from Dow Chemical Company)

### Component E

Solution containing a cross-linking agent: 7028 (containing polydimethylsiloxane having an Si—H group)

### Component F

Epoxy group-containing silane coupling agent: 3-glycidoxypropyltrimethoxysilane (KBM-403 from Shin-Etsu Chemical Co., Ltd.)

### EXAMPLE 1

Component A and Component C were added to a solvent, toluene, and stirred to prepare Liquid 1, and Component D was added to a solvent, toluene, and stirred to prepare Liquid 2, and then Liquid 1 and Liquid 2 were mixed and defoamed to prepare an adhesive composition.

Table 1 below shows the contents of reactive silicone-based resin, silica with an epoxy group, MQ-type silicone-based resin, catalyst, and cross-linking agent, based on the solid content in the adhesive composition. In Table 1 below, the units of \textcircled{1} to \textcircled{4}, \textcircled{6}, \textcircled{7} are parts by weight, the units of \textcircled{5} are ppm. In Table 1 below, “−” means that the corresponding component is not included.

A predetermined amount of the prepared adhesive composition was applied to one side of a transparent polyurethane-based film (water contact angle at 25° C.:70° with an applicator, dried at 80° C. for 2 minutes and at 130° C. for 3 minutes, and a PET release film was laminated on the adhesive coating film. Afterward, it was aged at 40° C. for 2 days to manufacture an adhesive sheet laminated in the following order: the transparent polyurethane-based film/the silicone-based adhesive film (thickness: 15 μm)/the PET release film.

### EXAMPLES 2 to 4

An adhesive sheet was manufactured in the same manner as in Example 1, except that the adhesive composition was prepared by adjusting the added amounts of Liquid 1 and Liquid 2 and/or the added amounts of Components A to F.

### Comparative Example 1

An adhesive sheet was manufactured in the same manner as in Example 1, except that Component A, 7663, which is a reactive silicone-based resin containing polydimethylsiloxane and capped with dimethylvinyloxy groups at both ends on silicon (Si), was used and the content of each component was changed according to Table 1 below.

### Comparative Examples 2 to 4 and Comparative Example 7

An adhesive sheet was manufactured in the same manner as in Example 1, except that the content of each component in Comparative Example 1 was changed according to Table 1 below.

### Comparative Example 5

Component B and Component C were added to a solvent, toluene, and stirred to prepare Liquid 1, Component D was added to a solvent, toluene, and stirred to prepare Liquid 2, and Liquid 1 and Liquid 2 were mixed and defoamed to prepare an adhesive composition.

An adhesive sheet was manufactured in the same manner as in Example 1 using the prepared adhesive composition.

### Comparative Example 6

An adhesive sheet was manufactured in the same manner as in Comparative Example 5, except that the adhesive composition was prepared by adjusting the added amounts of Liquid 1 and Liquid 2 and/or the added amounts of Components A to F.

The following physical properties of the adhesive sheets manufactured in Examples and Comparative Examples were evaluated, and the results thereof are shown in Table 2 below.
(1) Haze (units: %): In Examples and Comparative Examples, an alkali-free glass plate was used instead of a transparent polyurethane-based film, and a sample, in which a silicone-based adhesive film and a PET release film were laminated on one side of the alkali-free glass plate, was manufactured in the same manner. The PET release film was peeled off, and the haze value was measured using a haze meter NDH-9000. The alkali-free glass plate does not affect the haze of the silicone-based adhesive film.
(2) Curing: For each adhesive sheet manufactured in Examples and Comparative Examples, the curing of the silicone-based adhesive film was determined. Through the naked eye, it was evaluated as o when the silicone-based adhesive film was well cured, maintained its shape properly, and exhibited an adhesive property without any residue on the hand after being touched. It was evaluated as x when the shape of the silicone-based adhesive film was not maintained properly and there was a spillage or residue on the hand.
(3) Peel strength (units: gf/inch): After peeling off the PET release film from each adhesive sheet manufactured in Examples and Comparative Examples and cutting into a 100 mm×25 mm (width×height) piece, a sample was manufactured by pressing the 100 mm×25 mm (width x height) PET film laminate, in which an anti-fingerprint layer was formed on the upper surface (anti-fingerprint layer is fluorine-based and the water contact angle at 25° C. is 105°, NRF75, SKC Co., Ltd.,), with a 2 kg roller in order to bond the adhesive film and the anti-fingerprint layer, and leaving it at room temperature for 30 minutes. The manufactured sample was attached to a peel strength measurement device, TA.XT Plus Texture Analyzer (TA Instruments), and the peel strength was measured when the laminate of the silicone-based adhesive film and the polyurethane-based film was peeled off of the anti-fingerprint layer at a peeling temperature of 25° C., a peeling speed of 300 mm/min, and a peeling angle of 180°.
(4) Liquid stability: The initial viscosity was measured at 25° C. for 1 g of the adhesive compositions prepared in Examples and Comparative Examples. Adhesive compositions having the same weight were left at 25° C. for 1 hour and then the viscosity was measured in the same manner. When the viscosity increase rate of the following Equation 1 was less than 50%, it was evaluated as ○, and it was evaluated as x when the viscosity increase rate was more than 50%. Viscosity was measured using a viscosity measurement device, LV DV-II Pro (Brookfield Engineering Laboratories, Inc.) with a No. 40 spindle.

$$Viscosity increase rate = [ ( V 2 - V 1 ) / V 1 ] \times 100 \qquad [ Equation 1 ]$$

In Equation 1, VI is the initial viscosity of the adhesive composition (units: cps), V2 is the viscosity after leaving the adhesive composition at 25° C. for 1 hour (units: cps).

TABLE 1

| | \textcircled{1} | \textcircled{2} | \textcircled{3} | \textcircled{4} | \textcircled{5} | \textcircled{6} | \textcircled{7} |
|---|---|---|---|---|---|---|---|
| Example 1 | 70 | 30 | — | 5 | 400 | 0.7 | — |
| Example 2 | 70 | 30 | — | 5 | 600 | 0.7 | — |
| Example 3 | 70 | 30 | — | 7 | 400 | 0.7 | — |
| Example 4 | 70 | 30 | — | 7 | 400 | 0.7 | — |
| Comparative Example 1 | 70 | — | — | — | 200 | 0.7 | — |
| Comparative Example 2 | 70 | — | — | — | 400 | 0.7 | — |
| Comparative Example 3 | 70 | — | — | 5 | 400 | 0.7 | — |
| Comparative Example 4 | 70 | — | — | 7 | 400 | 0.7 | — |
| Comparative Example 5 | 70 | — | 30 | 5 | 200 | 0.7 | — |
| Comparative Example 6 | 70 | — | 30 | 5 | 400 | 0.7 | — |
| Comparative Example 7 | 70 | — | — | 5 | 400 | 0.7 | 30 |

* In Table 1 above,
\textcircled{1}: Reactive silicone-based resin
\textcircled{2}: Silica having epoxy group
\textcircled{3}: Silica having methyl group
\textcircled{4}: MQ-type silicone-based resin
\textcircled{5}: Catalyst
\textcircled{6}: Cross-linking agent
\textcircled{7}: Epoxy group-containing silane coupling agent

TABLE 2

| | | | | | Liquid |
|---|---|---|---|---|---|
| | Thickness | Haze | Curing | Peel strength | stability |
| Example 1 | 15 | 0.32 | ∘ | 30 | ∘ |
| Example 2 | 15 | 0.25 | ∘ | 30 | ∘ |
| Example 3 | 15 | 0.26 | ∘ | 40 | ∘ |
| Example 4 | 25 | 0.36 | ∘ | 45 | ∘ |
| Comparative | 15 | — | x | Unmeasurable | ∘ |
| Example 1 | | | | | |
| Comparative | 15 | 0.24 | ∘ | 5 | ∘ |
| Example 2 | | | | | |
| Comparative | 15 | 0.23 | ∘ | 10 | ∘ |
| Example 3 | | | | | |
| Comparative | 15 | 0.35 | ∘ | 12 | ∘ |
| Example 4 | | | | | |
| Comparative | 15 | — | x | Unmeasurable | x |
| Example 5 | | | | | |
| Comparative | 15 | — | ∘ | 30 | x |
| Example 6 | | | | | |
| Comparative | 15 | — | x | Unmeasurable | x |
| Example 7 | | | | | |

As shown in Table 2, the silicone-based adhesive film of the present invention had high peel strength and excellent liquid stability on the difficult-to-adhere-to anti-fingerprint layer, was formed on a transparent polyurethane-based film, and exhibited excellent processability due to a high curing degree.

On the other hand, the adhesive films of Comparative Examples that did not satisfy the composition of the adhesive film of the present invention did not show all the effects of the present invention.

Simple modifications or changes of the present invention can be easily implemented by those skilled in the art, and all modifications or changes can be considered to be included in the scope of the present invention.

1. A silicone-based adhesive film formed of a composition for an adhesive film comprising:
a reactive silicone-based resin;
an MQ-type silicone-based resin;
inorganic particles having a reactive functional group; and
a catalyst,
wherein the silicone-based adhesive film has a peel strength of 20 gf/inch or more, which is measured on the surface of an anti-fingerprint layer.

2. The silicone-based adhesive film of claim 1, wherein the catalyst is included in an amount of more than 0 ppm and 1 wt % or less in the adhesive film.

3. The silicone-based adhesive film of claim 1, wherein the MQ-type silicone-based resin is a non-reactive silicone-based resin.

4. The silicone-based adhesive film of claim 1, wherein the MQ-type silicone-based resin includes an organopolysiloxane resin containing an R¹R²R³SiO_{1/2} unit (R¹, R², and R³ are each independently an alkyl group having 1 to 6 carbon atoms) (M unit) and an SiO_{4/2} unit (Q unit).

5. The silicone-based adhesive film of claim 4, wherein the MQ-type silicone-based resin includes an organopolysiloxane resin consisting of only M units and Q units.

6. The silicone-based adhesive film of claim 1, wherein the reactive functional group includes one or more of an epoxy group, a (meth)acryloyloxy group, a (meth)acrylate group, and a mercapto group.

7. The silicone-based adhesive film of claim 6, wherein the epoxy group is a glycidoxy group, a glycidoxy propyl group, an epoxycyclohexyl group, an epoxycyclohexylethyl group, or an epoxycyclohexylmethyl group.

8. The silicone-based adhesive film of claim 1, wherein the inorganic particles having the reactive functional group have a refractive index of 1.3 to 2.0.

9. The silicone-based adhesive film of claim 1, wherein the inorganic particles having the reactive functional group have an average particle diameter (D50) of more than 0 nm and 10 μm or less.

10. The silicone-based adhesive film of claim 1, wherein the inorganic particles having the reactive functional group include silica.

11. The silicone-based adhesive film of claim 1, wherein the inorganic particles having the reactive functional group are included in an amount of 20 parts by weight to 70 parts by weight based on a total of 100 parts by weight of the reactive silicone-based resin and the inorganic particles having the reactive functional group.

12. The silicone-based adhesive film of claim 1, wherein the reactive silicone-based resin includes an organopolysiloxane containing at least one silicon-bonded vinyl group at a side chain or both ends.

13. The silicone-based adhesive film of claim 1, wherein, in the composition, the reactive silicone-based resin is included in an amount of 30 parts by weight to 80 parts by weight and the inorganic particles having the reactive functional group are included in an amount of 20 parts by weight to 70 parts by weight, based on a total of 100 parts by weight of the reactive silicone-based resin and the inorganic particles having the reactive functional group, and
the MQ-type silicone-based resin is included in an amount of 1 part by weight to 30 parts by weight based on a total of 100 parts by weight of the reactive silicone-based resin and the inorganic particles having the reactive functional group.

14. The silicone-based adhesive film of claim 1, wherein the composition further includes a cross-linking agent.

15. The silicone-based adhesive film of claim 1, wherein the anti-fingerprint layer has a water contact angle of 95° or more at 25° C.

16. An optical member comprising:
a base film; and
the silicone-based adhesive film of claim 1, which is laminated on at least one side of the base film.

17. The optical member of claim 16, wherein the base film includes a transparent polyurethane-based film.

18. An optical display device comprising the silicone-based adhesive film of claim 1.
